(19) United States
(12) Patent Application Publication
(10) Pub. No.: US 2008/0164256 A1
(43) Pub. Date: Jul. 10, 2008

(54) Small Sized and High-Pressurized Container for Preventing Explosion

(76) Inventors: Don-Woo Youm, Seoul (KR); Byoung-Gu Kim, Chungcheongnam-do (KR); Do-Young Gil, Busan (KR)

Correspondence Address: Quarles Brady LLP, 411 E Wisconsin Ave, Milwaukee, WI, 53202, US

(21) Appl. No.: 10/561,606

(22) PCT Filed: Jun. 24, 2004
(86) PCT No.: PCT/KR2004/001519

§ 371 Date: Feb. 12, 2008

(30) Foreign Application Priority Data
Jun. 24, 2003 (KR) 10 2003 0041132

(51) Int. Cl. F17C 13/12

(52) U.S. Cl. 220/203.08; 220/89.2; 220/612

(57) ABSTRACT

The present invention discloses a small sized and high-pressurized container for preventing explosion. According to the preferred embodiment of the present invention, a can body has a shape of cylinder for containing high-pressurized product therein. An upper body, which has a dome-like shape, is connected to the top of the can body by seaming or welding, and comprises a groove around its lower part. A valve is mounted on the top of upper body, and discharges high-pressurized gases or liquids, which exists in the inside of the container. A plurality of scores is configured at the bottom of the groove of the upper body, in order to discharge an overpressurized product and prevent bursting or explosion of the container. The scores weaken the resistance of the upper body, so in the event of that a certain internal overpressure is applied, the upper body firstly deforms outwardly and then one or more scores are fractured, and lastly the overpressurized product is discharged from the scores.

### TECHNICAL FIELD

The present invention relates to a small sized and high-pressurized container, more specifically, for preventing explosion.

A small sized and high-pressurized container comprises pressurized liquid or solid contents therein like a butane gas container, a hair sprayer, an insecticide or a fire extinguisher, and is used to discharge contents therein by a propellant and the like at high speed.

This small sized and high-pressurized container easily explodes if it is applied with excessive heat from the outside while it is circulated or used and the pressure inside of the container rises.

Particularly, since a butane gas container contains fuel and is used by being disposed in a heating apparatus like portable gas range, it is liable to be heated from the outside. This butane gas container is not dangerous in a normal condition, but the likelihood of explosion becomes very high if the safety equipment of a gas range is broken or if it is misused without keeping the safety rules indicated on the butane gas container or the gas range.

If a fire broke out during circulation or storage, pieces broken from the explosion of a small sized and high-pressurized container might injure people and this danger made it difficult to approach the fire spot to extinguish the fire, which might result in a massive blaze.

Also, remaining contents within a used-up container sometimes caused explosion during incineration.

In order to prevent the explosion, a small sized and high-pressurized container has been developed, in such a manner when the internal pressure of the small sized and high-pressurized container rises above the reference pressure, the top of the container is deformed and gets a vent to discharge the internal gas, so that the internal pressure gets lowered and explosion can be prevented.

### BACKGROUND TECHNOLOGY

This small sized and high-pressurized container is described in U.S. Pat. No. 3,850,339, which was granted to American Can Company as of Nov. 26, 1974.

FIGS. 1 and 2 show a container, generally designated 12, comprising a tubular body 14 having a side seam 15. Closing the bottom of the container is an end 16 hermetically seamed to the bottom of the body 14 by a seam 18.

As the container 12 will ultimately be utilized as an aerosol container, a dome 20 is seamed to the top of the body 12 by an annular, convoluted, double seam (five layers of interfolded material) 22. The upper end of the dome 20 has a vent 23 defined by a top curl. After filling the container with product, a dispensing valve for suitably dispensing product and propellant, is placed into the orifice 23, and the container is sealed by crimping. Then, the container is filled with a propellant through the valve.

A plurality of radial venting scores 26 are formed, preferably with a scoring punch when the dome 20 is flat in the area that is to be the top of the double seam 22.

The scores 26 are narrow grooves formed around the circumference of the dome 20 and penetrate in the given depth through the metal of the dome 20.

However, the manufacturing process and management are difficult since a plurality of groups each consisting of three thin scores should be formed radially at the top of the dome 20. Thus, this container is not effective.

In other words, since the scores 26, operation parts, are placed in the circumference of the dome 20, they may be broken if they are pressed at the time of seaming, which results in leakage of gas. Accordingly, since the scores 26 are made to have a predetermined thickness, sometimes a vent was not formed easily during the operation.

Further, the scores 26 must get a great shock in order to burst to form a vent when the top of the can is deformed, but the structure of an aerosol can according to the conventional art was not effective since the shock applied to the scores 26 was weak only to permit the scores 26 to be just a little curved when the top of the can is deformed, which made it difficult to form a vent.

### SUMMARY OF THE INVENTION

The present invention has been conceived in order to resolve the aforesaid problems. The technical task of the present invention is to provide a small sized and high-pressurized container, which can prevent explosion, by positioning scores at the bottom of the groove of the upper body of a container instead of the circumference of a dome to make it easy to break the scores.

For the purpose, preferred embodiment of the present invention discloses a small sized and high-pressurized container for preventing explosion, comprising a can body for containing high-pressurized contents therein; an upper body, which has a predetermined dome-like shape, is connected to the top of the can body by seaming, and comprises a groove around its lower part; a valve, which is crimped on the top of the upper body and extended from the inside of the can body to the outside of the upper body, in order to discharge the high-pressurized contents in the can body and inside of the upper body; a plurality of scores configured at the bottom of the groove of the dome-like upper body, in order to discharge the high-pressurized contents inside of the can body to the outside when the upper body is deformed.

The scores have the thickness from 0.03 mm to 0.08 mm, the size from 0.1 mm² to 4.0 mm², and the number of 4 to 20. Their shapes are not confined.

### BRIEF DESCRIPTION OF THE DRAWINGS

The present invention will be more clarified with detailed explanation by referring to the following drawings attached hereto.

In the drawings attached,

FIG. 1 is a side elevational view of the small sized and high-pressurized container according to the conventional art.

FIG. 2 is a top plane view according to FIG. 1.

FIG. 3 is a perspective view of the small sized and high-pressurized container for preventing explosion according to the preferred embodiment of the present invention.

FIG. 4 is a top plane view of the small sized and high-pressurized container for preventing explosion according to FIG. 3.

FIG. 5 is a fragmentary vertical cross-sectional view of the small sized and high-pressurized container for preventing explosion according to FIG. 3.

FIGS. 6 and 7 are fragmentary vertical cross-sectional views showing the deformed conditions of the small sized and high-pressurized container for preventing explosion according to FIG. 3.

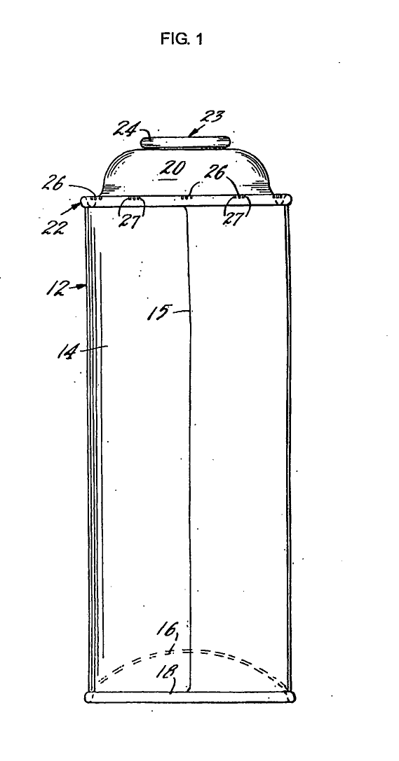

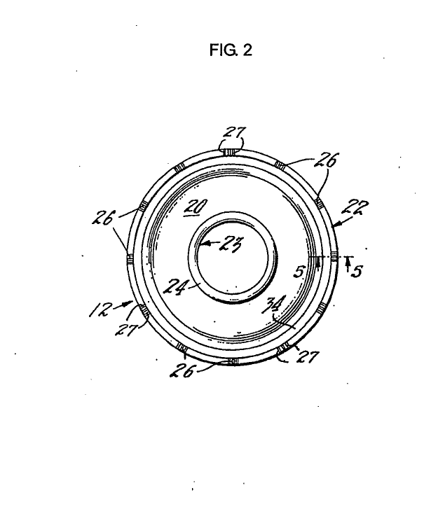

### DETAILED DESCRIPTION OF THE PREFERRED EMBODIMENT

Hereinafter, we will detailedly explain the small sized and high-pressurized container for preventing explosion according to the preferred embodiment of the present invention by referring to the drawings attached hereto.

The small sized and high-pressurized container for preventing explosion 100 according to the preferred embodiment of the present invention comprises a can body 110 for containing high-pressurized contents therein; an upper body 120, which has a predetermined dome-like shape, is connected to the top of the can body 110 by seaming, and comprises a groove 121 around its lower part; a valve 130, which is crimped on the top of the upper body 120 and extended from the inside of the can body 110 to the outside of the upper body, in order to discharge the high-pressurized contents in the can body 110 and inside of the upper body 120; a plurality of scores 122 configured at the bottom of the groove 121 of the dome-like upper body 120, in order to discharge the high-pressurized contents inside of the can body 110 to the outside.

It is desirable that the thickness of the scores 122 is 0.03 mm-0.08 mm, and the size of the scores 122 is 0.1 mm²-4.0 mm².

The number of the scores 122 is 4-20, and the shape of the scores 122 is not confined.

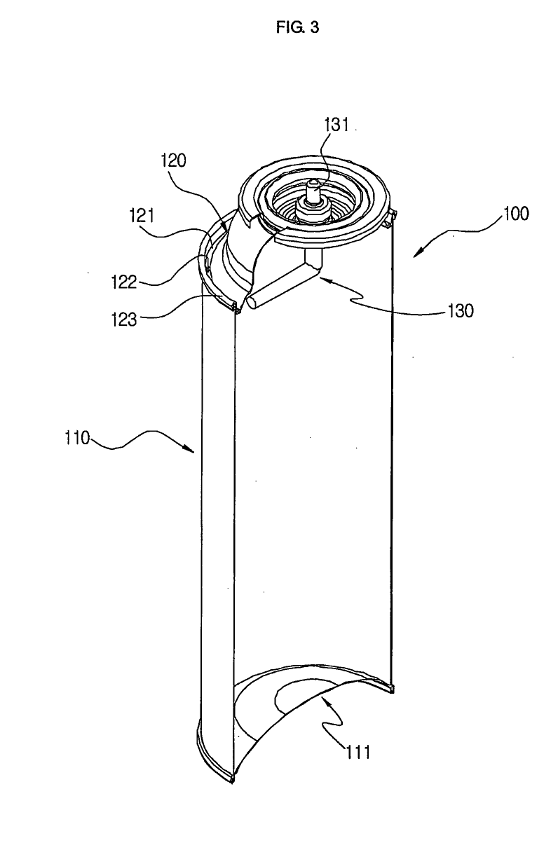

Referring to FIG. 3, the can body 110 of the small sized and high-pressurized container for preventing explosion 100 according to the preferred embodiment of the present invention having cylindrical shape with a closed bottom surface comprises high-pressurized contents therein. The bottom surface of the can body 110 has a bottom plate 111 connected to the circumference of the can body 110 by seaming. It is desirable that the bottom plate 111 is made in such a manner when the internal pressure in the container 100 develops, it equalizes the pressure distribution to increase the stability, and that it is made in the shape of a convex dome for the convenience of storage.

Inside of the can body 110, generally a crude liquid and a pressurized gas are contained together. A small butane gas container or an aerosol sprayer like the preferred embodiment of the present invention contains a liquefied pressurized gas.

The end part of the dome-like upper body 120 radially extends to the outside, and a groove 121 is placed at the predetermined position along the circumference of the end part. The upper body 120 is disposed at the upside of the can body 110, its terminal end is connected to the circumference of the can body 110 by seaming. The groove 121 is disposed inside of the connection part by seaming 123 between the upper body 120 and the can body 110.

The valve 130 is a tubular member to adjust the flow of the high-pressurized contents within the can body 110, and is connected to the top of the upper body 120 by crimping. One end of the valve 130 is placed inside of the can body 110, the other end is extended to the outside of the upper body 120 which is connected to the can body 110 by seaming.

A stem 131 for controlling the high-pressurized contents inside of the container to discharge them outside is placed at the top of the valve 130, which is located outside of the upper body 120.

The scores 122 are to discharge a pressurized gas to the outside when the internal pressure of the container 100 increases above the reference pressure. The shape of the scores 122 can be point, dotted line or polygon and so on. It is desirable that the scores 122 are formed at the lower part of the groove 121 at the terminal end of the dome-like upper part 120, and a plurality of scores are formed along the terminal end of the upper body 120.

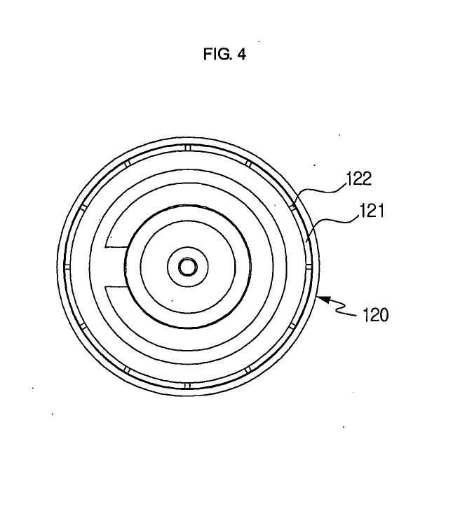

Referring to FIG. 4, a plurality of scores 122 are formed at the lower part of the groove 121 along the circumference of the upper body 120. This structure makes it possible to discharge the internal gas of the container to the outside by deforming the upper body 120 and breaking the scores 122 when the container 100 is overpressurized than the reference pressure. Thus, explosion of the container can be avoided. In other words, these scores 122 weaken the resistance power of the upper body 120 against external deformation. Accordingly, when the container is overpressurized, the upper body 120 rises up toward the upside and at least one scores 122 are broken. Then, the overpressurized contents in the container are discharged to the outside of the container through the broken scores 122.

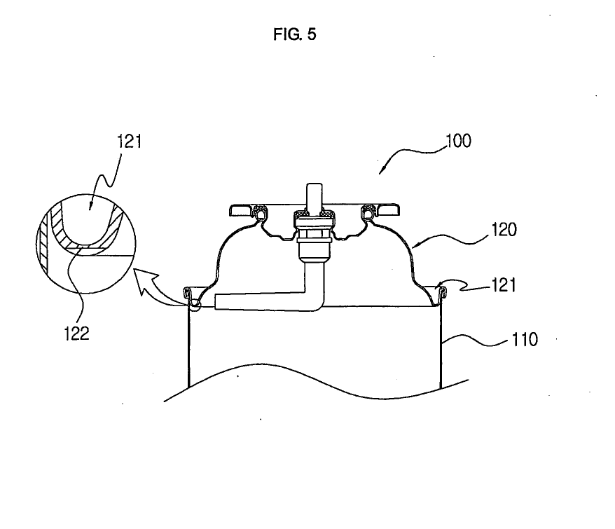

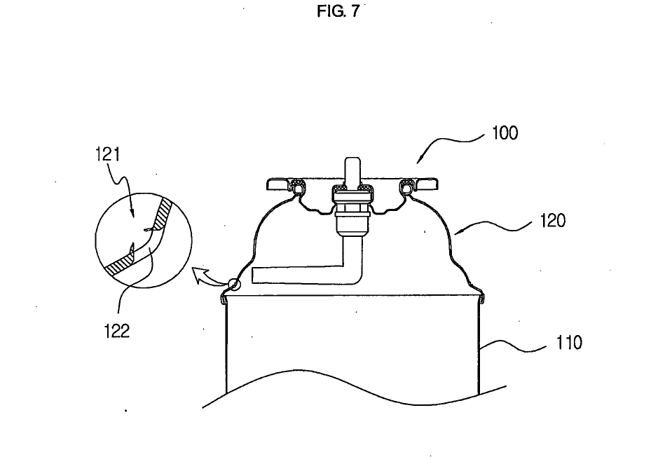

Referring to FIGS. 5-7, we will explain the structure and deformed condition of the above scores 122 more specifically.

First of all, in the small sized and high-pressurized container for preventing explosion 100 in an ordinary condition, as shown in FIG. 5, a groove 121 of the upper body 120 is positioned along the circumference around the can body 110. Scores 122 are arranged in the form of a plurality of points at the rear of the upper body 120 which forms the groove 121. Initially, the cross section of the scores 122 is horizontal as shown in FIG. 5.

When heat or power is applied from the outside, the internal pressure of the container 100 rises and when the container is overpressurized, the groove 121 formed around the upper body 120 rapidly rises up toward outside of the container. Accordingly, the upper body 120 is deformed while the groove 121 of the upper body is flattened.

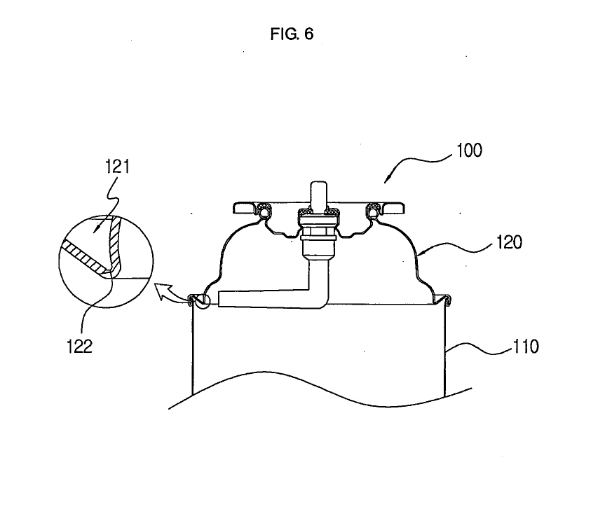

The upper body 120 and the scores 122 are deformed in the early stage of deformation, as illustrated in FIG. 6. The circumference of the upper body 120 is connected firmly with the can body 110 of the container by seaming, so it is rarely deformed. Also, the groove 121 of the upper body 120, which forms the scores 122, is rapidly lifted due to the internal pressure of the container 100.

The places of the scores in which the stress is concentrated are broken due to the deformation of the upper body 120 which is resulted from the deformation of the groove 121, and the groove 121 of the upper body 120 gets a vent. When the scores 122 are open, the pressurized gas remaining in the container 100 is discharged through the scores 122, thereby preventing the upper body 120 from being broken away at high speed from the can body 110 of the container by explosion.

Meanwhile, in order to determine preferred configuration, number, etc. of the scores 122 for the small sized and high-pressurized container for preventing explosion according to the preferred embodiment of the present invention, we carried out experiments by applying hydraulic pressure to the small sized and. high-pressurized container 100.

First, we deformed the upper body of the small sized and high-pressurized container 100 to open scores 122 and removed bottom plate 111 of the can body 110. Thereafter, we turn the small sized and high-pressurized container 100 upside down, and put 400 g of water therein and measured the time required for 100 g of water to flow out through the scores 122 without applying additional pressure.

As a result of the experiment, we found that the scores 122 to be less than 0.02 mm thickness can be broken at the time of manufacturing and the scores 122 to be greater than 0.09 mm are not broken with shock when the upper body 120 is deformed by the internal pressure of the container 100 and could not avoid explosion of the container 100.

Also, when we formed the size of the scores 122 to be less than 0.1 mm², the scores 122 could be broken but their holes are too small to discharge the remaining gas inside of the container 100 in time. Thus, in this case, the effect of preventing explosion is not sufficient. When we formed the size of the scores 122 to be more or less 1.0 mm², the gas could be discharged rapidly and could obtain the sure effect of preventing explosion.

In addition, when the number of the scores 122 was less than four, the discharge of gas through the scores 122 was slow. Thus, the effect of preventing explosion of the small sized and high-pressurized container 100 was diminished. Also, when the number of the scores 122 was twenty or more, distance between the scores was too narrowed and the upper body 120 was deformed only a little. Thus, the scores 122 could not get enough shock to be broken well, while the deformation pressure got lowered by 0.5 kg/cm² or more.

Thus, the result of the above experiments revealed that most desirable condition for the scores 122, the thickness of the scores 122 is more or less 0.05 mm, the size is more or less 1.0 mm² and the number is more or less 12.

Hereinafter, we will detailedly explain the operation of the small sized and high-pressurized container for preventing explosion 100 according to the preferred embodiment of the invention.

The small sized and high-pressurized container 100 having the aforementioned constitution has a can body 110 and an upper body 120 which are connected with each other by seaming and comprises high-pressurized contents therein. The above high-pressurized contents are crimped at the top of the upper body and provided to the outside of the container through a valve 130, which extends from the inside of the can body 110 to the outside of the upper body 120, and a stem 131 at the top of the valve 130.

At this time, if the safety rules in using the small sized and high-pressurized container 100 are not observed or heat is applied to the container 100, the pressure of the high-pressurized contents in the container 100 rises and with explosion the upper body 120 is separated from the can body 110 of the container 100. In the small sized and high-pressurized container for preventing explosion 100 according to the preferred embodiment of the invention, before the upper body 120 is absolutely separated from the can body 110, the groove 121 of the upper body 120, wherein the scores 122 are formed, is deformed. Thus, as illustrated in FIGS. 5 to 7, the groove 121 of the upper body 120 gets folded and unfolded while it moves toward the outside of the can body 110.

While the groove 121 of the upper body 120 moves outward of the can body 110 and is deformed, stress is concentrated on the scores 122 which have relatively weaker strength than the remaining parts of the upper body 120 and the material composing of the upper body 120 is fractured. The scores 122 are broken and open in this principle, so that the gas inside of the container 100 can be discharged to the outside through the scores 122. Thus, since the internal pressure of the container 100 decreases, the upper body 120 is not broken away from the can body 110 at high speed. Therefore, explosion of the small sized and high-pressurized container 100 can be avoided.

### INDUSTRIAL APPLICABILITY

As described above, the small sized and high-pressurized container for preventing explosion 100 according to the preferred embodiment of the present invention forms a plurality of point-shape scores at the bottom of the groove around the upper body. Thus, when the internal pressure of the container rises by abnormal external heat or power, the gas charged in the container can be discharged to the outside through the scores in advance before the upper body is separated from the can body and the container is exploded. Therefore, explosion of the small sized and high-pressurized container can be avoided.

Further, the scores are formed at the bottom of the groove of the upper body, so they receive concentrated stress when the upper body is deformed. Thus the scores can be easily broken, and fire and accident due to explosion of remaining gas can be avoided.

Moreover, the scores are not formed in the seam between the can body and the upper body, but formed at the bottom of the groove of the upper body, so even if a strong shock is applied to the seam in the circumference of the container during circulation, like dropping the container, the shock is not transferred to the scores directly. Thus, the container is not easily broken during ordinary use.

Hereinbefore, we illustrated and described only the small sized and high-pressurized container for preventing explosion 100 according to the preferred embodiment of the present invention. However, the present invention is not confined only to the above embodiment. Instead, it can be modified variously by whoever skilled in the art to which the present invention pertains within the scope of the subject matters of the present invention claimed in the claims.

1. A small sized and high-pressurized container for preventing explosion, comprising
a can body for containing high-pressurized contents therein;
an upper body, which has a predetermined dome-like shape, is connected to the top of said can body by seaming, and comprises a groove around its lower part;
a valve, which is crimped on the top of said upper body and extended from the inside of said can body to the outside of said upper body, in order to discharge the high-pressurized contents in said can body and inside of said upper body;
a plurality of scores configured at the bottom of the groove of said dome-like upper body, in order to discharge the high-pressurized contents inside of said can body to the outside.

2. The small sized and high-pressurized container for preventing explosion according to claim 1, characterized in that the thickness of said scores is from 0.03 mm to 0.08 mm.

3. The small sized and high-pressurized container for preventing explosion according to claim 1, characterized in that the size of said scores is from 0.1 mm²-4.0 mm².

4. The small sized and high-pressurized container for preventing explosion according to claim 1, characterized in that the number of said scores is from 4 to 20.

5. The small sized and high-pressurized container for preventing explosion according to claim 1, characterized in that the shape of said scores is circle or polygon.
